(19) United States
(12) Patent Application Publication
(10) Pub. No.: US 2005/0137872 A1
(43) Pub. Date: Jun. 23, 2005

(54) System and method for voice synthesis using an annotation system

(76) Inventor: Corey E. Brady, Charlottesville, VA (US)

Correspondence Address: TEXAS INSTRUMENTS INCORPORATED, P O BOX 655474, M/S 3999, DALLAS, TX, 75265, US

(21) Appl. No.: 10/865,304

(22) Filed: Jun. 10, 2004

Related U.S. Application Data
(60) Provisional application No. 60/532,789, filed on Dec. 23, 2003.

(51) Int. Cl. G10L 15/00

(52) U.S. Cl. 704/269

(57) ABSTRACT

A speech to text conversion and annotation system. In an embodiment, the system displays an annotated text corresponding to computer rendered speech and allows a user to adjust voicing and pronunciation parameters of the annotated text; and use a text to speech engine to render the annotated text to a human like generated voice that has modified voicing and pronunciation corresponding to the user selected voicing and pronunciation parameters. In another embodiment, a read-aloud coaching system is introduced that allows a student to “incrementally program” a voice synthesis engine, thoughtfully and purposively creating his or her own reading of a literary text.

### TECHNICAL FIELD OF THE INVENTION

This invention relates to voice synthesis and more particularly to an annotation system for voice-to-text and text-to-voice conversion. In an embodiment a method for teaching and creating auditory performances of literary texts using the text-voice annotation system is described.

### BACKGROUND OF THE INVENTION

In the English/Language Arts classroom, the practice of reading poetry and other literature aloud has a long history. Many teachers use read-aloud in a variety of ways, with teachers, individual students, or “choral groups” performing the read-aloud for the benefit of the class. These text-performances can provide an entry point for discussions of the text that focus on interpretive choices of the readers, identification of critical “cruxes” (points in the text from which multiple interpretations arise, depending on how that point is ‘handled’), and so forth.

A reading performance involves a choice of and commitment to a “reading”—that is an interpretation of the text. The performance aspect of reading aloud makes the latent thinking visible to the student (as they prepare and make choices) and to the class (as they watch and discuss the performance). The “reading” that is presented is always obviously one of many. The performer will have contended with some of these alternatives in preparing; the class will see more as the presented reading surprises them. Thus, with the appropriate support in the classroom community, reading performances can be healthy and mind-opening ways to engage with language and use language to achieve consciously-chosen effects on a particular audience.

There are several traditional barriers to using reading performances effectively in classrooms. It can be stressful. Without a supportive classroom learning community, performances can be high-risk events for students. Even within a supportive classroom, some students are reluctant to deliver a performance themselves. It takes time. Performances can take a great deal of class time—teachers have to dedicate a lot of their instructional hours to these activities to make them happen. During the reading, the student-performer has a difficult time focusing on anything but the mechanics of delivery. Because of the exertion required to deliver the text, the student is unable to think about the poem as an artistic object, during the performance. It turns out to be very difficult to be both performer and critical listener at the same time. It is hard to capture. Unless there are video cameras, recording equipment, and so forth in the room, the performance is hard to hold on to. Even with recording, it's hard to use the recording for instructional or evaluative ends. It is hard to evaluate. Given the personal risk that students can take, and the difficulty of holding on to the artifact of the performance, it's not always easy to assign a grade to a read-aloud performance.

Prior art “performance simulation” environments have focused on the planning or conceptualization of a stage-theatrical event or movie (i.e., costume choices, blocking, script creation, etc.)—rather than on the linguistic engagement with an oral performance. Other Educational applications of voice synthesis have tended either toward perfecting automated speech (which is antithetical in intent to this invention) or on providing scaffolding (assistive technology) for students who have difficulty in decoding or in reading fluently.

### SUMMARY OF THE INVENTION

A first embodiment is a speech to text conversion and annotation system. In this embodiment, the system displays an annotated text corresponding to computer rendered speech and allows a user to adjust voicing and pronunciation parameters of the annotated text; and use a text to speech engine to render the annotated text to a human like generated voice that has modified voicing and pronunciation corresponding to the user selected voicing and pronunciation parameters. This system could be used to annotate text as described in the read-aloud coaching system or other embodiments such as computer telephone answering systems, computer generated speech systems of all kinds where it is desirable to modify the speech output to interject a specific variation of speech parameters such as phonemes, prosody, tone, and volume. The present invention anticipates that the specific uses of such a system are virtually limitless.

Another embodiment is designed to solve many of the problems associated with read-aloud, by providing read-aloud coaching system and method that allows a student to “incrementally program” a voice synthesis engine, thoughtfully and purposively creating his or her own reading of a text. The programming of the voice synthesis engine takes the form of creating an annotated version of the text that is understood by the voice synthesis engine.

An embodiment of the present invention provides a method for teaching and creating auditory performances of literary texts. A preferred embodiment of the invention consists of five combined “layers”: a voice synthesis engine with sufficient flexibility to capture nuances and variation of phonemes, prosody, tone and intonation, and volume; an annotation system that allows for humans to express their desires for read-aloud performance in a regular manner; a mapping of the annotation system onto the functionality of the voice-synthesis engine; a user interface for “coaching” and for “dry-running/debugging” the emerging performance; and a linked ‘reflective journal’ in which annotations that are added to the text in the dry-run/debug cycle can be supported or justified by the user, for future reference by the student herself or by others (as, for example, a teacher). In this environment, the student interacts with a computing device, using the annotation system to comment on and improve the annotation-enhanced text, which is iteratively “run” by the voice-synthesis engine.

Advantages of an embodiment of the present invention include a more reflective and process-revealing environment for read-aloud performances, an improved means of comparing multiple performances of the same text in a way that facilitates comparison, contrast, and other forms of analysis, an annotation system that can extend outside of the technology environment, enriching classroom discussions of oral performances, promotes skills of “critical reading” and “critical listening” in students, and it engages students in making conscious choices as they render literary texts orally.

Most uses of speech-synthesis have focused on improving computer algorithms for automatically rendering arbitrary text in a “human-like” manner. These approaches typically assume there is a single “target” rendering of the text that will be lifelike and that this lifelike rendering is achievable through machine rendering. This invention takes an alternate approach that provides several advantages. In the present invention, instead of striving for transparency between the text and the speech output, it seeks to intervene in the algorithm by providing the user with an interface that supports incremental, iterative design of the speech output.

One advantage is the usefulness in an educational environment. In an embodiment of the present invention, it is actually an advantage that voice-synthesis algorithms for choosing prosody, intonation, and the like are not uniformly satisfactory. The “gap” between the automatic reading and the student's desired reading provides an acute ‘teachable moment’ as described in Phase 1 of the scenario below. Thus, another advantage of an embodiment of the present invention is that it allows the student/user to produce a unique synthesized reading of the text that incorporates the student/user's own interpretation of the mood and meaning of the text.

### BRIEF DESCRIPTION OF THE DRAWINGS

FIG. 1 illustrates a hand-held device having features according to the present invention.

FIGS. 2-5 illustrate a graphical user interface annotation system according to another embodiment of the present invention.

### DETAILED DESCRIPTION OF THE PRESENT INVENTION

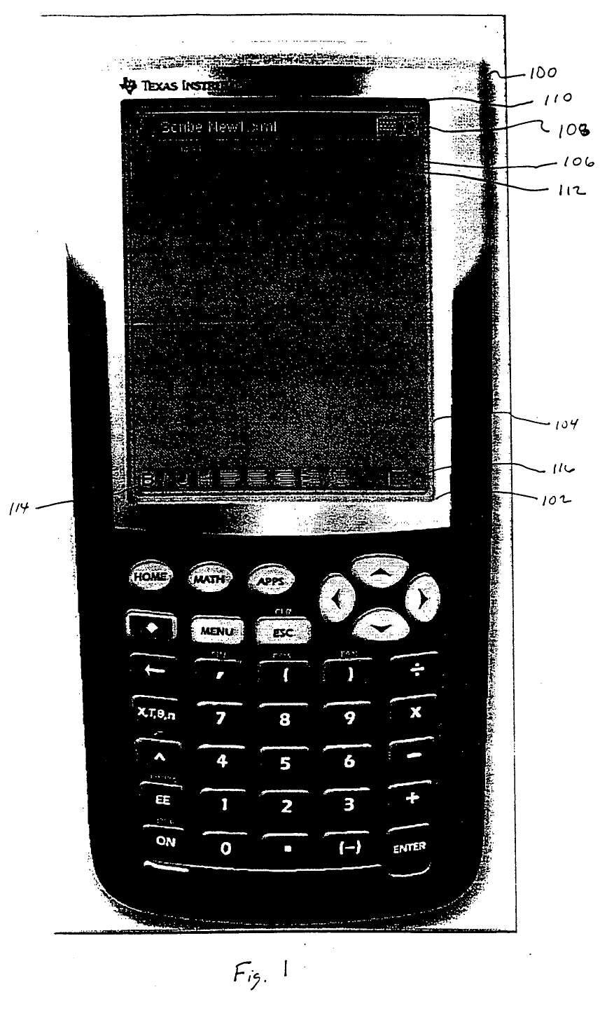

FIG. 1 illustrates a computer or hand held computing device 100 that incorporates features of the present invention. The device has a display screen 102 having a display area 104. In this embodiment, the display is a touch sensitive display that uses a stylus for input (not shown). The device executes software described herein stored in memory 101 on the micro-processor 303.

The display includes a header bar 106 that shows the current tool (in this case a document editor tool). The file name of the current open document on the display is also shown on the header bar. In addition, the header bar shows an icon for closing the tool 108 and a keyboard icon 110 to bring up a “QWERTY” keyboard on the display for input of characters with the stylus. The display area 104 further includes a top button bar 112 that has drop down menus for file, edit, insert and view functions. The display area 104 also has a bottom button bar 114 that has text formatting options, a keyboard button, and an icon 116 to pop-up another menu for inserting text symbols.

A first embodiment of the present invention provides a method for teaching and creating auditory performances of literary texts. A preferred embodiment of the invention consists of five combined “layers”: a voice synthesis engine with sufficient flexibility to capture nuances and variation of phonemes, prosody, tone and intonation, and volume; an annotation system that allows for humans to express their desires for read-aloud performance in a regular manner; a mapping of the annotation system onto the functionality of the voice-synthesis engine; a user interface for “coaching” and for “dry-running/debugging” the emerging performance; and a linked ‘reflective journal’ in which annotations that are added to the text in the dry-run/debug cycle can be supported or justified by the user, for future reference by the student herself or by others (as, for example, a teacher). In this environment, the student interacts with a computing device, using the annotation system to comment on and improve the annotation-enhanced text, which is iteratively “run” by the voice-synthesis engine.

Phase 1. Initial “reading”. The student is tasked with creating a reading for a poem. She begins either by providing an initial annotation of the text (based on her own “first pass” thoughts on how she would like to render the poem) or by simply invoking the speech engine on the raw (un-annotated) text. Typically, this first reading will seem highly unsatisfactory to the student. She will likely describe the reading of a raw text as “inhuman,” or “unfeeling,” and if she has begun with an initial annotation set, she will feel that the synthesized reading has “missed” key things about the poem that need to be expressed in the reading.

Thus the synthesized reading of the poem creates a natural “teachable moment” in a number of senses. The student, by placing herself in the position of the Audience, strongly feels the need to correct the faulty or incomplete reading. She knows precisely and viscerally what was “wrong” with the presented reading; and this perception is very often easily linked to a critical opinion about the meaning of the text itself. These responses create a heightened awareness of the interpretive choices that a reading implies—and they create the beginnings of a thought process in the student, toward making conscious and deliberate choices about the text.

Phase 2. Dry-Run/Debug Cycle. After the initial reading, the student works through the annotation interface, “coaching” the voice-synthesis system on how she feels the poem should be read. At any point, she can “run” the reading or any section of it. In the preferred implementation, the student selects and annotates segments of the text with performance markup through a simple interface, which layers performance and commentary information on top of a word-processor document metaphor. For example, a selection of text could be marked for idiosyncratic pronunciation or emphasis (e.g., this particular ‘e’ pronounced as a schwa); special volume or pacing controls (e.g., 10% faster, 15% louder, and so forth); or even a change in speaking voice (e.g., change to adult female or to named voice x).

The essence of this phase is that the student is able to plan and direct a reading performance by consciously manipulating reading choices and observing the effects of these choices.

In this phase, the student moves quickly and fluidly back and forth between the roles of Coach and Audience member. At each “running” of the performance, she develops an increasingly strong understanding of the “reading” that she is creating—and of the implications of that reading for the way that an audience will receive and understand the poem. By using the reflective journal, she can capture a record both of the “errors” that the voice-synthesis engine made in rendering the text, and of the deliberate choices and “what if” scenarios she has done in continuously refining her performance.

This cycle proceeds until the student is satisfied with the reading.

Phase 3. Performance. This phase is the most activity-dependent one. That is, in different instructional contexts, the ways that the product of Phase 2 will be used will vary considerably. For example . . .
1. this machine reading and annotation could have an entirely planning role. The student might turn in the machine-performance as “what I was planning” but actually perform the poem herself—perhaps using a printout of a suitably readable version of the text+markup to be used as a guide for this human performance.
2. the machine reading could be used as a part of the performance. The student might “play” it for the class. Of course, this doesn't have to be the only part of the performance—having the machine-reading might free the student to take another ‘role’ to augment the performance in some way (e.g., act it out with gesture, assume critical distance and comment on the machine-reading afterwards, talk about the construction of the reading or the experience of making the machine act that way, etc.)
3. either after or independently from “out-loud” performances, different student readings might be compared. The annotation provides a systematic way of comparing choices that students have made, and a comparison of the annotations allows for a discussion at a useful level of abstraction of different performances. The reflective journals can help to prompt the memories of the students for why they have made the choices they have made.
4. there might not even be an actual public “running” of the poem—the student, the teacher, or a student group” might use the annotation-script and/or the reflective journal entries to understand the learning process that has occurred.

Another embodiment of the present invention is an annotation system that may be used separately from a computing environment, as students with pencil and paper could use the system to make shorthand performance notes—either in preparing for reading aloud or in describing/capturing the performances of others. Thus, the “method” of annotating texts for the purpose of performing them orally can be separated from the “apparatus” (the software) for rendering those annotations with a text-to-speech (TTS) engine. The annotation method should provide a simple description of many of the oral variations that are treated in TTS software and in phonetic analysis (phonetic variation, pitch and intonation, volume, pacing, prosody, pausing, etc.)

Graphical User Interface of an Annotation System

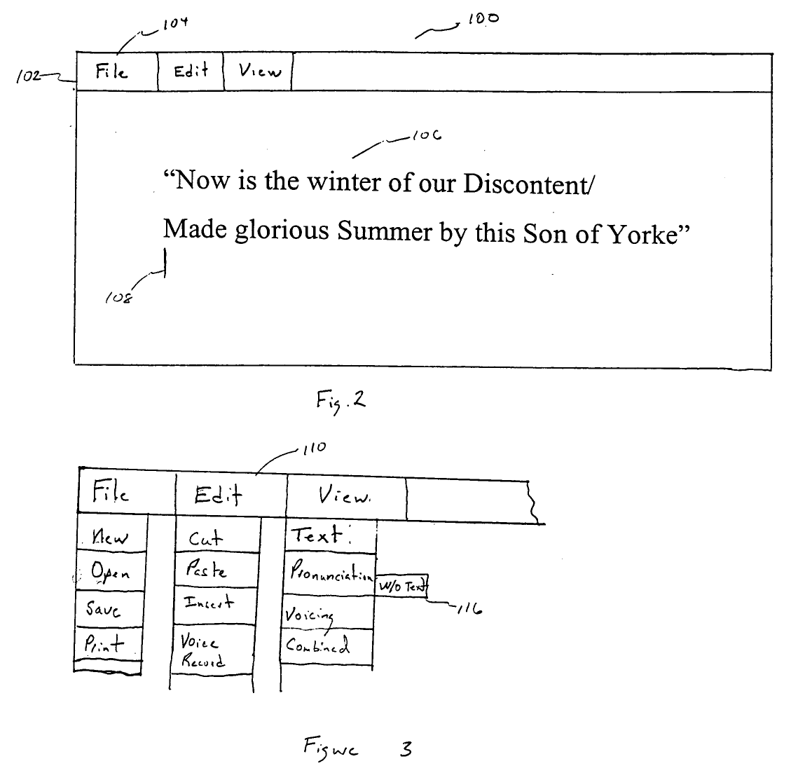

Another embodiment of the present invention is shown in FIGS. 2-5. This embodiment is a text to speech annotation system that is incorporated in a graphical user interface for a computer or handheld computing device. The annotation system allows the user to input a work for rendering by the annotation system by either text input or verbal input. The user then can annotate the input to modify the speech output using the graphical interface and/or voice commands. The annotations system supports an iterative process such that the user can “play back” the rendering in specified sections or the entire work at any time and then again proceed with annotations to further enhance the annotated speech output. This system could be used to annotate text as described in the above read-aloud coaching system or other embodiments such as computer telephone answering systems, or any computer generated speech systems where it is desirable to modify the speech output to interject a specific variation of speech parameters such as phonemes, prosody, tone, and volume. The present invention anticipates that the specific uses of such a system are virtually limitless. The system could also be used to allow a user to modify the output of a computer's own “voice” in a computer system where the computer has a voice interface.

FIG. 2 shows a representation of a display screen 100 of the annotations system according to the present invention. The display 100 includes a menu bar 102 with drop down menu items as is common in prior art computer menus. The menu bar includes a “file” option 104, which contains common file input output selections. For example, it may have new file, open file, save file, print file, and etc. as shown in FIG. 3.

In the first example shown in FIG. 2 a target text or input work 106 is shown in the main edit area of the screen. This text may be imported into the annotation system as an ordinary text file, or as an annotation file which was created previously using the file open command described above. In another case, the input work may be simply typed by the user at the location of the cursor 108 in the same manner as an ordinary text editor. In a third case, the input work may be input by voice from the user. This can be done by selecting a voice record button such as shown in FIG. 3 in the edit drop down menu 110. The voice record button activates a voice to text synthesizer to input a work into the annotation system. In the preferred embodiment, the voice to text synthesizer converts the user's voice to text in addition to setting the voicing and pronunciation parameters for the text as these parameters are further described below.

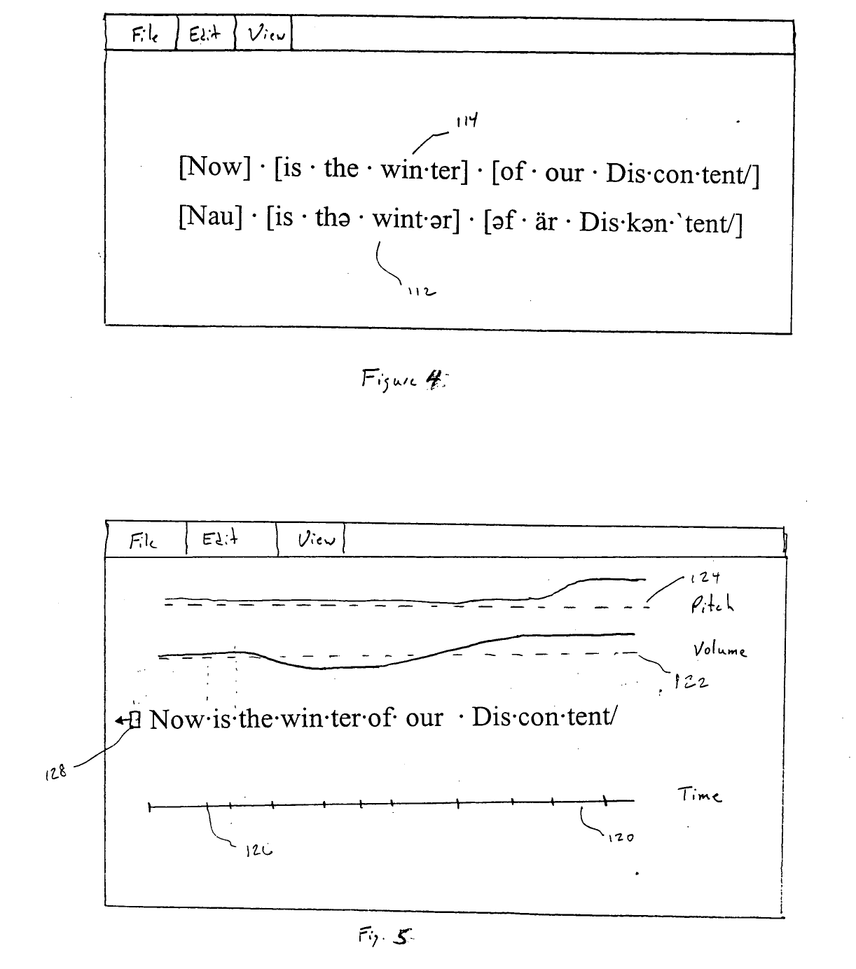

The annotation system preferably has two primary edit modes, pronunciation and voicing. The pronunciation edit mode allows the user to edit the utterance chunking and the sounds to letters correspondence. This edit mode is shown in FIG. 4. The screen view shown in FIG. 4 results from selecting the pronunciation menu item shown in FIG. 3 from the screen shown in FIG. 2. A portion of the work is displayed in the edit screen as shown in FIG. 4. The cursor can be used to scroll through the work like is done with a prior art text editor (not shown).

As shown in FIG. 4. The pronunciation edit mode displays the pronunciation 112 of the work using pronunciation characters like those used in dictionaries. The pronunciation edit mode may also display the ordinary text 114 if desired, or turned off by selecting the “w/o text” sub-menu item 116. The pronunciation may be edited by the user by selecting a word or phoneme to be changed. In a preferred embodiment, the change is made from a pop-up menu when the user right-clicks the pointer.

FIG. 4 further shows the utterance chunking edit mode according to an embodiment of the present invention. The utterance chunking allows the user to control the chunks or portions of the text that are commonly treated by the annotation parameters. The chunking is indicated in the display by special symbols such as parenthesis or brackets. The chunking can be edited by the user by moving the cursor and inserting the symbols at the desired locations.

FIG. 5 shows the voicing edit mode according to an embodiment of the present invention. The voice edit mode allows the user to vary the timing of the voicing, the volume and the pitch. When the user selects this mode, timing 120, volume 122 and pitch scales 124 are displayed. If the work has just been created from text then a default scale would be used. The default scale may be equal to the base line of the scale. The base lines of the scales are indicated by the dash line of the scale. If the work was created previously or by voice entry, then the stored scales for the displayed portion of the work would be shown.

The timing scale 120 allows the user to adjust the timing of the rendered speech from the annotated text. The scale includes timing marks 126 located at each syllable break or timing interval. Each of the syllable breaks is individually stretchable and compressible. The user selects a timing mark and uses the pointer or cursor to move the timing marks to increase or decrease the time for the selected syllable or portion of text. FIG. 6 shows the timing for the word “our” has been increased by pulling the timing marks further apart than normal. Also, the timing scale for the entire work can be adjusted by moving the beginning and ending timing “knobs” 128 (ending knob not shown).

In a similar manner, the user can adjust the volume and pitch for a specified portion of the text. The user selects a portion of the volume or pitch scale using the pointer or cursor an pulls the scale in the selected location up or down to modify the scale. In FIG. 5 the pitch scale has been raised over the last portion of the word “discontent.”

### OTHER EMBODIMENTS

Although the present invention has been described in detail, it should be understood that various changes, substitutions, and alterations could be made hereto without departing from the spirit and scope of the invention as defined by the appended claims. For example, the graphical interface tools may be re-arranged and modified in many ways with known interface icons and methods.

The features that are the subject of the present invention could be incorporated into other into other computer based teaching tools and computers. Similarly, other embodiments include the same user interface functionality in a ROM software application package that is executed on a computer, graphing calculator or other handheld device.

1. An article comprising a medium storing software that causes a processor-based computer system to perform the following steps:
a. display an annotated text corresponding to computer rendered speech;
b. allow a user to adjust voicing and pronunciation parameters of the annotated text; and
c. use a text to speech engine to render the annotated text to a human like generated voice that has modified voicing and pronunciation corresponding to the user selected voicing and pronunciation parameters.

2. The article of claim 1 further comprising the step of allowing the user to input the text using a speech to text recognition engine.

3. The article of claim 1 further comprising the step of allowing the user to input the text using a speech to text recognition engine that also detects the users voicing and pronunciation to supply baseline parameters of the annotated text.

4. The article of claim 1 further comprising the step of allowing the user to input the text using a keyboard input like used in common text editors.

5. The article of claim 1 wherein the step of allowing the user to input voicing and pronunciation for the annotated text includes pitch, volume and timing.

6. The article of claim 1 wherein the computer system is part of an automated phone answering system.

7. The article of claim 1 wherein the user may annotate text that is the computer systems output so that the output of the computer in the form of auditory voice speech can be modified by the user.

8. A portable computing device, comprising:
a. a processor;
b. a memory coupled to the processor; and
c. a storage medium coupled to the processor including a software program that, upon execution:
i. displays an annotated text corresponding to computer rendered speech;
ii. allows a user to adjust voicing and pronunciation parameters of the annotated text; and
iii. uses a text to speech engine to render the annotated text to a human like generated voice that has modified voicing and pronunciation corresponding to the user selected voicing and pronunciation parameters.

9. The article of claim 8 further comprising the step of allowing the user to input the text using a speech to text recognition engine.

10. The article of claim 8 further comprising the step of allowing the user to input the text using a speech to text recognition engine that also detects the users voicing and pronunciation to supply baseline parameters of the annotated text.

11. The article of claim 8 further comprising the step of allowing the user to input the text using a keyboard input like used in common text editors.

12. The article of claim 8 wherein the step of allowing the user to input voicing and pronunciation for the annotated text includes pitch, volume and timing.

13. A method of teaching the auditory rendering of a literary work comprising the following steps:
a. the student generates an initial rendering of a textual literary work using a text to speech engine;
b. allowing the student to adjust voicing and pronunciation parameters of the annotated text; and
c. using a text to speech engine to render the annotated text to a human like generated voice that has modified voicing and pronunciation corresponding to the user selected voicing and pronunciation parameters.

14. The method of claim 13 further comprising the step of allowing the student user to input the text using a speech to text recognition engine.

15. The method of claim 13 further comprising the step of allowing the student user to input the text using a speech to text recognition engine that also detects the users voicing and pronunciation to supply baseline parameters of the annotated text.

16. The method of claim 13 further comprising the step of allowing the student user to input the text using a keyboard input like used in common text editors.

17. The method of claim 13 wherein the step of allowing the student user to input voicing and pronunciation for the annotated text includes pitch, volume and timing.
